(19) United States
(12) Patent Application Publication
(10) Pub. No.: US 2026/0100122 A1
(43) Pub. Date: Apr. 9, 2026

(54) WILDFIRE MONITORING SYSTEM FOR REAL-TIME RISK ASSESSMENT

(71) Applicants: Arizona Board of Regents on Behalf of Arizona State University, Scottsdale, AZ (US); Wisconsin Alumni Research Foundation, Madison, WI (US)

(72) Inventors: Jennifer Blain Christen, Chandler, AZ (US); Anamitra Pal, Gilbert, AZ (US); Randy Essikpe, Phoenix, AZ (US); Umit Ogras, Madison, WI (US); Line Roald, Madison, WI (US); Elisabeth Graffy, Madison, WI (US)

(21) Appl. No.: 19/348,459

(22) Filed: Oct. 2, 2025

Related U.S. Application Data
(60) Provisional application No. 63/702,851, filed on Oct. 3, 2024.

(51) Int. Cl. G08C 17/02; A62C 3/02; G01K 1/024; G01N 19/10; G01P 5/00

(52) U.S. Cl. CPC G08C 17/02; G01K 1/024; G01N 19/10; G01P 5/00; A62C 3/02

(57) ABSTRACT

A system may be configured for continuous wildfire risk assessment and notification in remote terrain environments. The system may obtain environmental sensor readings from a first sensor suite, where the readings include at least temperature, humidity, and windspeed data local to the first sensor suite. The system may calculate a Hot, Dry, and Windy (HDW) index value using the environmental data and determine whether the HDW index value satisfies a threshold value. Responsive to the HDW index value satisfying the threshold value, the system may activate a second sensor suite characterized by a higher energy consumption than the first sensor suite. The system may then obtain smoke and infrared readings from the second sensor suite, detect wildfire conditions based on the smoke and infrared readings, and transmit a wildfire alert to a remote system responsive to detecting the wildfire conditions.

### CLAIM OF PRIORITY

This application claims the benefit of U.S. Patent Application No. 63/702,851, filed 3 Oct. 2024, the entire contents of which is incorporated herein by reference.

### GOVERNMENT RIGHTS AND GOVERNMENT AGENCY SUPPORT NOTICE

This invention was made with government support under 2132904 awarded by the National Science Foundation. The government has certain rights in the invention.

### TECHNICAL FIELD

Aspects of the disclosure relate generally to environmental monitoring, including systems for assessing wildfire risk in remote terrain environments.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed subject matter.

Monitoring systems are utilized in various environmental and infrastructure contexts. For example, wildlife monitoring systems may employ camera traps, GPS collars, acoustic sensors, and drones to track animals and study behavior. Similarly, powerline monitoring systems may utilize inspections, surveillance cameras, sensors, alarms, and data analytics to ensure safe infrastructure management and minimize environmental impact.

Environmental monitoring approaches have also been applied to wildfire detection and risk management. Such approaches may include satellite imaging, unmanned aerial vehicles, or watchtower-based human observation. Each of these techniques may provide certain advantages, while also facing challenges related to coverage, cost, timeliness, or operational continuity.

### SUMMARY

This disclosure relates to systems and techniques for real-time wildfire risk assessment using a tiered sensor architecture. A first sensor suite, operating at relatively low power, can continuously collect environmental data such as temperature, humidity, and windspeed in a remote deployment area. These measurements can be processed to calculate a Hot-Dry-Windy (HDW) index, which serves as an indicator of local fire weather conditions. When the HDW index exceeds a defined threshold, the system transitions into a higher-resolution monitoring mode.

In this higher-resolution mode, a second sensor suite, which consumes greater energy, is activated to capture smoke and infrared readings that provide direct evidence of wildfire activity. The combined operation of the first and second sensor suites enables both proactive risk detection and confirmatory fire detection. If wildfire conditions are detected based on the second sensor suite, the system can transmit an alert to a remote monitoring system or emergency response center, thereby supporting timely awareness and mitigation actions in regions vulnerable to wildfire events.

In at least one example, processing circuitry is configured to perform a method that includes obtaining environmental sensor readings from a first sensor suite of a wildfire monitoring system, wherein the environmental sensor readings include at least temperature data, humidity data, and windspeed data local to the first sensor suite. According to certain examples, the method includes calculating a Hot, Dry, and Windy (HDW) index value using the temperature data, the humidity data, and the windspeed data. In at least one example, the method includes determining the HDW index value satisfies an HDW index threshold value. According to such examples, the method includes, responsive to determining the HDW index value satisfies the HDW index threshold value, activating a second sensor suite characterized by a higher energy consumption than the first sensor suite. In one example, the method includes obtaining, from the second sensor suite subsequent to activating the second sensor suite, smoke and infrared (IR) readings. In at least one example, the method includes detecting wildfire conditions based on the smoke and infrared (IR) readings. According to certain examples, the method includes, responsive to detecting the wildfire conditions, transmitting a wildfire alert to a remote system.

In at least one example, a system includes processing circuitry. According to certain examples, the system includes non-transitory computer-readable media storing instructions that, when executed by the processing circuitry, configure the processing circuitry to obtain environmental sensor readings from a first sensor suite of a wildfire monitoring system, wherein the environmental sensor readings include at least temperature data, humidity data, and windspeed data local to the first sensor suite. In at least one example, the system includes instructions that, when executed by the processing circuitry, configure the processing circuitry to calculate a Hot, Dry, and Windy (HDW) index value using the temperature data, the humidity data, and the windspeed data. According to such examples, the system includes instructions that, when executed by the processing circuitry, configure the processing circuitry to determine the HDW index value satisfies an HDW index threshold value. In one example, the system includes instructions that, when executed by the processing circuitry, configure the processing circuitry, responsive to determining the HDW index value satisfies the HDW index threshold value, to activate a second sensor suite characterized by a higher energy consumption than the first sensor suite. In at least one example, the system includes instructions that, when executed by the processing circuitry, configure the processing circuitry to obtain, from the second sensor suite subsequent to activating the second sensor suite, smoke and infrared (IR) readings. According to certain examples, the system includes instructions that, when executed by the processing circuitry, configure the processing circuitry to detect wildfire conditions based on the smoke and infrared (IR) readings. In one example, the system includes instructions that, when executed by the processing circuitry, configure the processing circuitry, responsive to detecting the wildfire conditions, to transmit a wildfire alert to a remote system.

In one example, computer-readable storage media comprise instructions that, when executed, configure processing circuitry to obtain environmental sensor readings from a first sensor suite of a wildfire monitoring system, wherein the environmental sensor readings include at least temperature data, humidity data, and windspeed data local to the first sensor suite. According to certain examples, the computer-readable storage media comprise instructions that, when executed, configure the processing circuitry to calculate a Hot, Dry, and Windy (HDW) index value using the temperature data, the humidity data, and the windspeed data. In at least one example, the computer-readable storage media comprise instructions that, when executed, configure the processing circuitry to determine the HDW index value satisfies an HDW index threshold value. According to such examples, the computer-readable storage media comprise instructions that, when executed, configure the processing circuitry, responsive to determining the HDW index value satisfies the HDW index threshold value, to activate a second sensor suite characterized by a higher energy consumption than the first sensor suite. In one example, the computer-readable storage media comprise instructions that, when executed, configure the processing circuitry to obtain, from the second sensor suite subsequent to activating the second sensor suite, smoke and infrared (IR) readings. In at least one example, the computer-readable storage media comprise instructions that, when executed, configure the processing circuitry to detect wildfire conditions based on the smoke and infrared (IR) readings. According to certain examples, the computer-readable storage media comprise instructions that, when executed, configure the processing circuitry, responsive to detecting the wildfire conditions, to transmit a wildfire alert to a remote system.

In a particular example, there is a device which includes means for obtaining environmental sensor readings from a first sensor suite of a wildfire monitoring system, wherein the environmental sensor readings include at least temperature data, humidity data, and windspeed data local to the first sensor suite. The device includes means for calculating a Hot, Dry, and Windy (HDW) index value using the temperature data, the humidity data, and the windspeed data. The device includes means for determining the HDW index value satisfies an HDW index threshold value. The device includes means for activating a second sensor suite characterized by a higher energy consumption than the first sensor suite responsive to determining the HDW index value satisfies the HDW index threshold value. The device includes means for obtaining, from the second sensor suite subsequent to activating the second sensor suite, smoke and infrared (IR) readings. The device includes means for detecting wildfire conditions based on the smoke and infrared (IR) readings. The device includes means for transmitting a wildfire alert to a remote system responsive to detecting the wildfire conditions.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of this disclosure.

FIG. 2 depicts a Wildfire Assessment Risk Management (WARM) system sensor suite and conceptual design highlighting capabilities of a WARM framework, in accordance with aspects of the disclosure.

FIG. 3 depicts an example prototype WARM sensor suite including sensor suite components as utilized by a WARM framework, in accordance with aspects of the disclosure.

FIG. 4 depicts sensor module components of a WARM sensor suite, in accordance with aspects of the disclosure.

FIG. 5 depicts a block diagram showing the operational data flow and component interactions within a WARM framework, in accordance with aspects of the disclosure.

FIG. 6 provides a logic diagram of a WARM framework which uses a tiered sensing approach to enable fire detection with limited access to power, in accordance with aspects of the disclosure.

FIG. 7 depicts a sensor performance graph showing sensor output under various conditions to mimic weather and fire environments, in accordance with aspects of the disclosure.

FIG. 8 depicts a risk assessment graph showing the risk levels based on the HDW index, in accordance with aspects of the disclosure.

FIG. 9 depicts a test enclosure including a WARM sensor suite along with a smoke source, a fan, and a handle, in accordance with aspects of the disclosure.

FIG. 10 is a flow diagram illustrating an example method for wildfire monitoring and detection, in accordance with aspects of this disclosure.

Like reference characters denote like elements throughout the text and figures.

### DETAILED DESCRIPTION

This disclosure relates to systems and techniques for real-time wildfire risk assessment using a tiered sensor architecture. A first sensor suite, operating at relatively low power, can continuously collect environmental data such as temperature, humidity, and windspeed in a remote deployment area. These measurements can be processed to calculate a Hot-Dry-Windy (HDW) index, which serves as an indicator of local fire weather conditions. When the HDW index exceeds a defined threshold, the system transitions into a higher-resolution monitoring mode.

In this higher-resolution mode, a second sensor suite, which consumes greater energy, is activated to capture smoke and infrared readings that provide direct evidence of wildfire activity. The combined operation of the first and second sensor suites enables both proactive risk detection and confirmatory fire detection. If wildfire conditions are detected based on the second sensor suite, the system can transmit an alert to a remote monitoring system or emergency response center, thereby supporting timely awareness and mitigation actions in regions vulnerable to wildfire events.

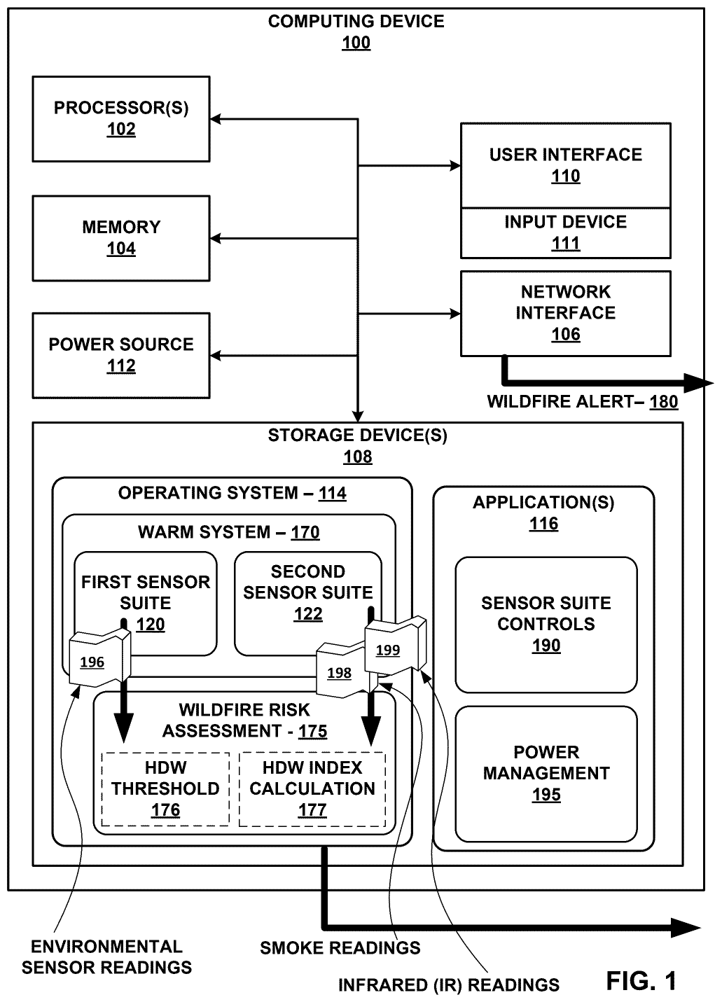

FIG. 1 is a block diagram illustrating further details of one example of computing device, in accordance with aspects of this disclosure. FIG. 1 illustrates only one particular example of computing device 100. Many other examples of computing device 100 may be used in other instances.

As shown in the specific example of FIG. 1, computing device 100 may include processor(s) 102, memory 104, network interface 106, storage device(s) 108, user interface 110, and power source 112. Computing device 100 may also include operating system 114. Computing device 100, in one example, may further include application(s) 116, including sensor suite controls 190 and power management 195 capable of activating first sensor suite 120 and second sensor suite 122 and transitioning sensor suites into and out of low-power sleep modes.

Operating system 114 may execute various functions of wildfire assessment risk management (WARM) framework 170 and its sensor suites to provide continuous monitoring of wildfire risk assessment suitable for remote terrain environments. WARM framework 170 may receive environmental sensor readings 196 from first sensor suite 120. Operating system 114 may calculate, within wildfire risk assessment 175, a hot, dry, and windy (HDW) index value using temperature data, humidity data, and windspeed data included in environmental sensor readings 196. Wildfire risk assessment 175 may include HDW threshold 176 and HDW index calculation 177 to compare the calculated HDW index value to one or more threshold values.

Sensor suite controls 190 may activate second sensor suite 122 responsive to HDW threshold 176 being satisfied. Second sensor suite 122 may provide smoke readings 198 and infrared (IR) readings 199 to wildfire risk assessment 175. Wildfire risk assessment 175 may combine smoke readings 198 and infrared (IR) readings 199 with HDW index calculation 177 to determine whether wildfire conditions are present. When wildfire conditions are detected, wildfire risk assessment 175 may generate wildfire alert 180. Wildfire alert 180 may be output through network interface 106 for transmission to a remote system.

In some examples, processing circuitry including processor(s) 102 implements functionality and process instructions for execution within computing device 100. For example, processor(s) 102 may process instructions stored in memory 104 and/or instructions stored on storage device(s) 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memory (RAM), dynamic random-access memory (DRAM), static random-access memory (SRAM), and other forms of volatile memories. In some examples, memory 104 may be used to store program instructions for execution by processor(s) 102. Memory 104, in one example, may be used by software or application(s) 116 running on computing device 100 to temporarily store data and/or instructions during program execution.

Storage device(s) 108, in some examples, may also include computer-readable storage media. Storage device(s) 108 may be configured to store larger amounts of information than memory 104. Storage device(s) 108 may further be configured for long-term storage of information. In some examples, storage device(s) 108 may include non-volatile storage elements. Examples of such non-volatile storage elements may include magnetic hard disks, optical discs, floppy disks, flash memories, or forms of electrically programmable read-only memory (EPROM) or electrically erasable programmable read-only memory (EEPROM).

Computing device 100, in some examples, may also include network interface 106. Computing device 100, in such examples, may use network interface 106 to communicate with external devices via one or more networks, such as wired or wireless networks. Network interface 106 may be a network interface card, such as an Ethernet card, an optical transceiver, a radio frequency transceiver, a cellular transceiver or cellular radio, or any other type of device that can send and receive information. Other examples of such network interfaces may include Bluetooth®, 3G, 4G, 5G, LTE, and Wi-Fi® radios in mobile computing devices as well as USB. In some examples, computing device 100 may use network interface 106 to wirelessly communicate with an external device such as a server, mobile phone, or other networked computing device. Network interface 106 may output wildfire alert 180 to an external system for further processing, monitoring, or dispatch to emergency services.

Computing device 100 may also include user interface 110. User interface 110 may include input device 111, such as a touch-sensitive display. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone, or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that can generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in storage device(s) 108 and may control the operation of components of computing device 100. For example, operating system 114 may facilitate the interaction of application(s) 116 with hardware components of computing device 100.

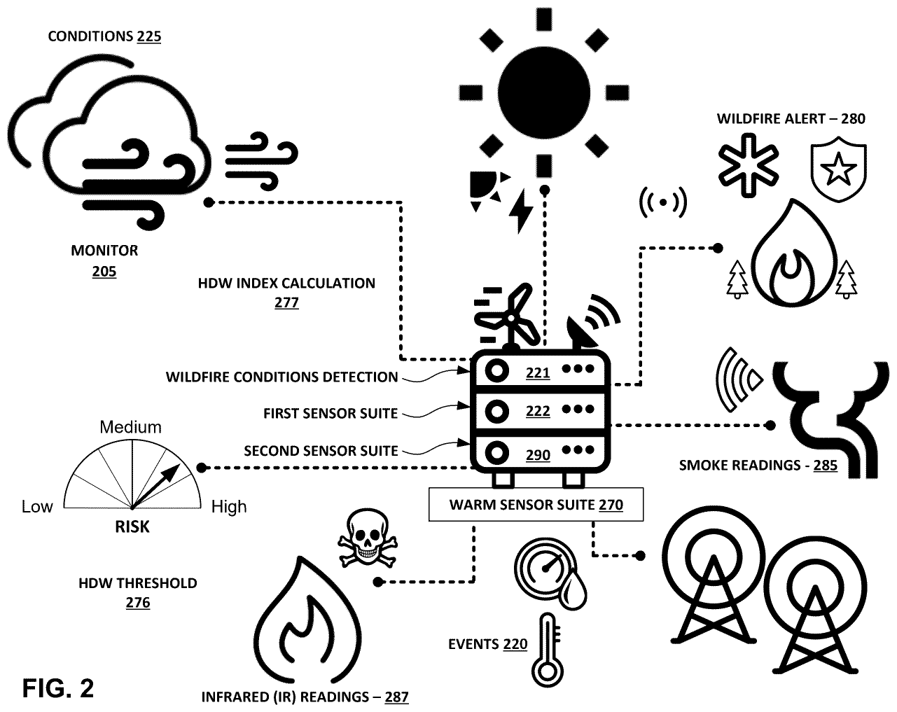

FIG. 2 depicts a Wildfire Assessment Risk Management (WARM) system sensor suite and conceptual design highlighting capabilities of WARM framework 170, in accordance with aspects of the disclosure. For instance, WARM sensor suite 270 operating in conjunction with WARM framework 170 is depicted here, enabling WARM framework 170 to monitor conditions 225 and events 220, perform HDW index calculation 277, determine whether the HDW index calculation 277 satisfies HDW threshold 276, activate first sensor suite 221 and second sensor suite 222, obtain smoke readings 285 and infrared (IR) readings 287, perform wildfire conditions detection 290, and generate wildfire alert 280 for communication to remote stakeholders.

Monitor 205 is depicted in FIG. 2 as part of WARM framework 170. Monitor 205 may include circuitry, software modules, or both configured to receive inputs corresponding to conditions 225 and events 220, and to coordinate HDW index calculation 277. Monitor 205 may operate continuously to evaluate environmental parameters such as temperature, humidity, and windspeed, and may compare these with one or more thresholds stored within WARM framework 170. Monitor 205 may further manage activation of first sensor suite 221 and second sensor suite 222 responsive to satisfaction of HDW threshold 276, thereby providing supervisory control of wildfire conditions detection 290 and issuance of wildfire alert 280.

### INTRODUCTION

Wildfires have long been a major source of destruction to property, human lives, and livelihoods, with numerous wildfire incidents recorded each year, resulting in varying forms of damage. In 2018, California experienced a total of 8,527 fires, covering an area of 1.9 million acres, which is close to 2% of the state's total landmass, approximately 7,700 km². In the United States, the average number of fires recorded from 2001 to 2020 was 68,000 per year, affecting a land area of 7 million acres.

The tendency or risk of wildfire outbreaks varies with changing weather conditions. Weather factors such as surface wind speeds, relative humidity, temperature, and general fuel moisture directly impact wildfire outbreaks and their spread across burned areas. Decreasing fuel moisture and dry weather create large areas of fuels more likely to ignite and sustain fire over longer periods. Rising surface wind speeds also increase the frequency of outbreaks, as winds can carry fire over long distances. These weather conditions are predominantly observed in summer each year, which features the highest annual temperatures and the lowest levels of precipitation.

Powerline events 220 involved in wildfires are particularly devastating, either directly causing fires or becoming entangled in the spread of fires. Powerlines belonging to Pacific Gas and Electric (PG&E) were correlated to more than 1,500 fires over six years, among the deadliest fires recorded, causing damage to hundreds of thousands of acres, resulting in billions of dollars in financial impact, and affecting hundreds of thousands of people. There is a pressing need to mitigate the damage caused by these fires and, by extension, reduce their incidence.

WARM framework 170 enables monitoring, preventing, and mitigating wildfire outbreaks using sensor networks. WARM sensor suite 270 may include first sensor suite 221 configured for lower-power environmental sensing and second sensor suite 222 configured for higher-power smoke and infrared (IR) sensing. Sensor inputs such as conditions 225 (e.g., temperature, humidity, and windspeed), and events 220 (e.g., electrical grid faults or gas emissions), are provided to WARM sensor suite 270 to enable continuous monitoring of risk. WARM framework 170 applies HDW index calculation 277 based on environmental inputs and compares the calculated HDW index to HDW threshold 276. Responsive to HDW threshold 276 being satisfied, WARM framework 170 activates second sensor suite 222 to obtain smoke readings 285 and infrared (IR) readings 287, which are processed by wildfire conditions detection 290. When wildfire conditions detection 290 confirms the presence of fire signatures, wildfire alert 280 is generated and communicated through external communication links to emergency responders and monitoring authorities.

Wildfire monitoring has recently seen significant advancements with real-time imaging and sensing. The most notable techniques described include satellite surveillance, Unmanned Aerial Vehicles (UAVs), and ground-based watchtower detection systems.

Satellite surveillance: Imaging techniques used in satellite surveillance help detect fires and smoke over vast land areas, making this approach appealing to many research groups. However, limitations include poor spatial resolution, high data processing demands, and costly deployment. Satellite detection, in particular, faces unique challenges during winter due to the presence of clouds obscuring active fires on the land. These challenges persist despite efforts to improve camera spatial resolution and artificial intelligence techniques in data processing.

Unmanned Aerial Vehicles: UAVs provide one viable solution for wildfire monitoring and mitigation. UAVs overcome the limitations of satellite-based detection systems and can monitor vast terrain and detect fires. UAVs can access areas that are dangerous and unreachable for humans, though continuous landscape observation presents challenges. UAVs require remote operation by a human for task allocation, leading to potential discontinuity in fire monitoring when the human operator is absent.

Ground-Based Watchtower Detection: Ground-based watchtower detection has been used for many years and remains effective. These systems operate continuously and do not encounter the challenges of satellite detection systems or UAVs. Use of such human-operated ground-based watchtowers, however, is costly both in terms of capital and human effort.

While WARM framework 170 does not provide fire suppression itself as may be done with firefighting UAVs or in-situ human operators stationed at watchtowers, WARM framework 170 provides continuous wildfire risk assessment and fire detection. The two-tiered approach enabled by first sensor suite 221 and second sensor suite 222, together with HDW index calculation 277, HDW threshold 276, smoke readings 285, infrared (IR) readings 287, wildfire conditions detection 290, and wildfire alert 280, enables efficient early warning and rapid detection of wildfire events.

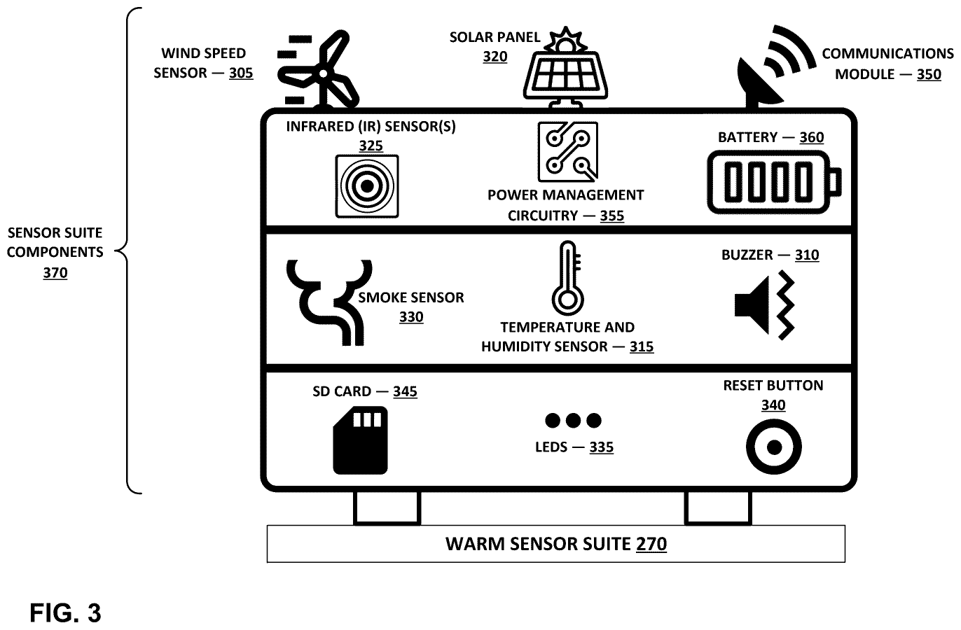

FIG. 3 depicts an example prototype warm sensor suite 270 including sensor suite components 370 as utilized by WARM framework 170, in accordance with aspects of the disclosure. Warm sensor suite 270 includes multiple hardware and sensing components that collectively enable continuous monitoring of environmental and fire-related conditions, risk assessment, and communication of wildfire alerts. Sensor suite components 370 include wind speed sensor 305, buzzer 310, temperature and humidity sensor 315, solar panel 320, infrared (IR) sensor(s) 325, smoke sensor 330, LEDs 335, reset button 340, SD card 345, communications module 350, power management circuitry 355, and battery 360.

Warm sensor suite 270 operates as an embedded subsystem of WARM framework 170, integrating environmental sensors, fire detection sensors, storage, energy harvesting, and wireless communication modules into a self-contained device. Warm sensor suite 270 is configured to receive environmental inputs from wind speed sensor 305, temperature and humidity sensor 315, infrared (IR) sensor(s) 325, and smoke sensor 330. These inputs are processed locally within power management circuitry 355 and related control modules to determine whether wildfire conditions exist based on monitored parameters. Warm sensor suite 270 further outputs to communications module 350 to transmit wildfire alert 280 messages to external monitoring stations or first responder networks.

Wind speed sensor 305 measures surface wind velocities, supporting calculation of the Hot, Dry, and Windy (HDW) index when combined with temperature and humidity readings from temperature and humidity sensor 315. Buzzer 310 provides audible output in local alarm scenarios, such as when wildfire conditions are detected or when maintenance personnel require immediate alerts at the installation site. Temperature and humidity sensor 315 monitors ambient temperature and relative humidity values, which are critical variables for wildfire risk assessment.

Solar panel 320 provides renewable energy harvesting to charge battery 360, enabling warm sensor suite 270 to operate continuously in remote terrain environments without dependence on external infrastructure. Battery 360 serves as an energy storage module, maintaining power reserves during periods of low or no solar input, such as during nighttime or inclement weather. Power management circuitry 355 regulates power distribution across warm sensor suite 270, selectively powering high-consumption modules such as infrared (IR) sensor(s) 325 and communications module 350 only when threshold conditions are satisfied, thereby extending operational lifetime. In some examples, the first sensor suite exhibits a first energy draw that is less than a second energy draw associated with operation of the second sensor suite. The power management circuitry may maintain the second sensor suite in a low-power sleep state during iterative operation of the first sensor suite. While in the low-power sleep state, the second sensor suite may consume less energy than the first energy draw of the first sensor suite, thereby enabling continuous monitoring of environmental conditions by the first sensor suite while reserving energy resources for selective activation of the second sensor suite under threshold conditions.

Infrared (IR) sensor(s) 325 detect radiated heat energy associated with active flames. Multiple infrared (IR) sensor(s) 325 may be arranged circumferentially on warm sensor suite 270 to provide full-field coverage, such as three infrared (IR) sensor(s) 325 positioned 120° apart. Smoke sensor 330 detects airborne particulates consistent with combustion, such as fine particulate matter or other smoke signatures, and may be arranged interleaved between infrared (IR) sensor(s) 325 to provide combined fire and smoke detection coverage at 60° intervals.

LEDs 335 provide visual status indicators for local observation of device health, operational status, or detection events. Reset button 340 allows manual resetting of warm sensor suite 270 in the field, for example to restart firmware or clear transient errors. SD card 345 provides local data logging and removable storage capability, allowing historical environmental readings, sensor diagnostics, and event logs to be retrieved and analyzed externally.

Communications module 350 enables wireless communication between warm sensor suite 270 and remote stations. In various examples, communications module 350 may include a LoRa transceiver for long-range, low-power communication, a cellular modem, a Wi-Fi® radio, or combinations thereof. Power management circuitry 355 selectively energizes communications module 350 in response to detected wildfire conditions to conserve energy.

Warm sensor suite 270 is designed to be deployed in remote terrains with limited infrastructure. The combination of solar panel 320, battery 360, and power management circuitry 355 ensures self-sustaining operation. Wind speed sensor 305, temperature and humidity sensor 315, infrared (IR) sensor(s) 325, and smoke sensor 330 provide real-time monitoring of conditions relevant to wildfire risk. Together, these components enable WARM framework 170 to calculate the HDW index, apply HDW threshold 276 values, and determine when wildfire alert 280 should be issued.

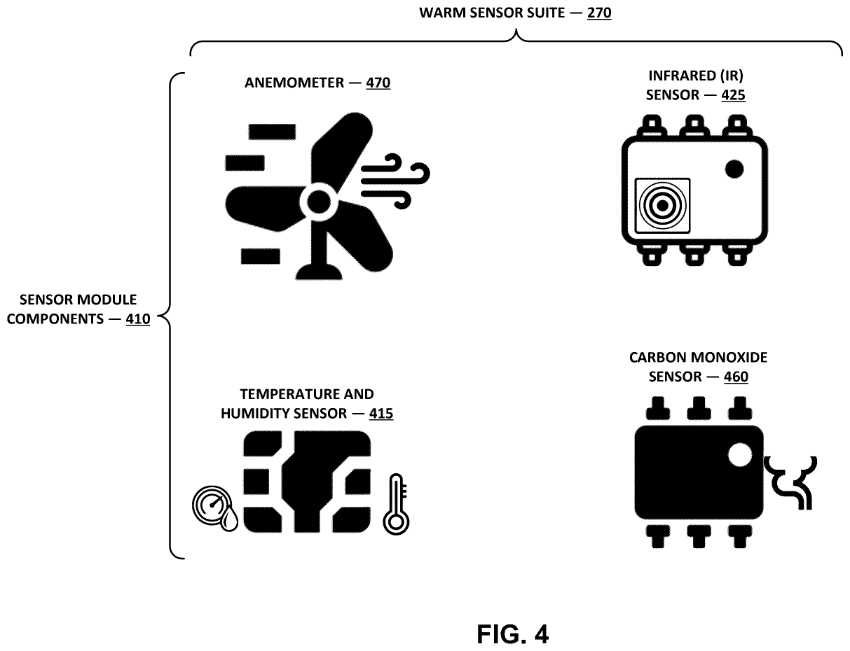

FIG. 4 depicts sensor module components 410 of WARM sensor suite 270, in accordance with aspects of the disclosure. Sensor module components 410 include anemometer 470, temperature and humidity sensor 415, carbon monoxide sensor 460, and infrared (IR) sensor 425. These modules provide multimodal environmental sensing, allowing WARM sensor suite 270 to capture atmospheric conditions, combustion byproducts, and radiation signatures that collectively support early wildfire risk detection and reporting.

Anemometer 470 is an instrument that measures wind speed and is a fundamental element in wildfire risk detection since wind strongly influences both ignition probability and fire spread. Types of anemometers include cup anemometers, vane anemometers, hot-wire anemometers, and ultrasonic anemometers. In one example, anemometer 470 may be implemented as a three-cupped CALT windspeed anemometer with a measurement range of 0-45 m/s. Anemometer 470 produces analog outputs corresponding to wind velocity, and these outputs are received by a microcontroller in WARM sensor suite 270 for continuous recording. In wildfire assessment contexts, wind speed measurements from anemometer 470 may be combined with temperature and humidity readings to evaluate the Hot, Dry, and Windy (HDW) index, which quantifies ignition likelihood and fire behavior potential.

Temperature and humidity sensor 415 provides simultaneous readings of ambient air temperature and relative humidity. In one example, temperature and humidity sensor 415 may be a Digital Humidity and Temperature (DHT11) sensor, which incorporates a resistive humidity measurement component and a thermistor. Temperature and humidity sensor 415 interfaces with a high-performance 8-bit microcontroller and provides digital signals for recording. Example ranges include a humidity measurement span of 20-90% RH with ±5% RH accuracy and a temperature measurement span of 0-50° C. with ±2° C. accuracy. Temperature and humidity sensor 415 data supports HDW index calculations and contributes to long-term climatological monitoring for fire risk assessment.

Carbon monoxide sensor 460 is a gas sensor configured to detect carbon monoxide, a common byproduct of combustion and a useful indicator of incipient wildfires or smoldering fire events. In one example, carbon monoxide sensor 460 may be implemented as an MQ7-type sensor manufactured by Winsen Electronics. Carbon monoxide sensor 460 operates using a heating and cooling cycle in which the sensing element is heated at 5 V to burn off gas residues and then cooled to 1.4 V for sensitive data acquisition. The sensor element consists of a micro aluminum oxide (Al₂O₃) ceramic tube, a tin dioxide (SnO₂) sensitive layer, a measuring electrode, and an integrated heater. Carbon monoxide sensor 460 provides analog voltage output that varies with carbon monoxide concentration, which is received and processed by WARM sensor suite 270 to detect the onset of fire-related gas emissions.

Infrared (IR) sensor 425 detects radiation in the infrared spectrum, which is commonly associated with open flame events and smoldering hotspots. IR sensor 425 includes a photodiode that exhibits high resistance in the absence of infrared radiation and reduced resistance when exposed to radiation. Sensitivity of IR sensor 425 may be modulated using an integrated variable resistor, enabling calibration for specific field conditions. In one example, IR sensor 425 may detect radiation signatures from embers or active flames, providing early warning inputs that complement gas detection from carbon monoxide sensor 460 and particulate detection from smoke sensor 330 described in FIG. 3.

Sensor module components 410 collectively feed data into WARM sensor suite 270, where microcontroller-based processing integrates outputs from anemometer 470, temperature and humidity sensor 415, carbon monoxide sensor 460, and infrared sensor 425. This multimodal approach ensures redundancy and enhances the reliability of wildfire detection, with each sensor compensating for limitations of the others. For example, temperature and humidity sensor 415 may indicate elevated fire risk under hot and dry conditions, carbon monoxide sensor 460 may register gas emissions during smoldering, and infrared sensor 425 may detect early flame signatures. The combined use of sensor module components 410 strengthens the ability of WARM sensor suite 270 to identify wildfires earlier and with greater accuracy than unimodal systems.

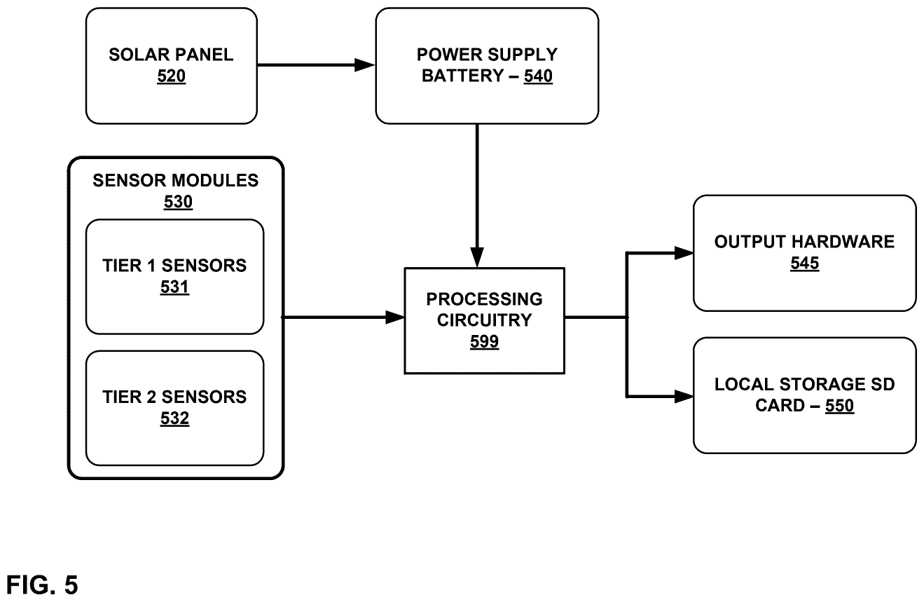

FIG. 5 depicts a block diagram showing the operational data flow and component interactions within WARM framework 170, in accordance with aspects of the disclosure. As shown, solar panel 520 provides harvested energy that feeds into power supply battery 540, which in turn provides operating power to processing circuitry 599, sensor modules 530, output hardware 545, and local storage SD card 550. Processing circuitry 599 may be implemented, for example, as an ATMega 329P or ATMega 2560 type microcontroller, or as other suitable microcontroller or microprocessor architectures, configured to coordinate data acquisition, manage tiered sensor activation, and execute risk assessment algorithms. Processing circuitry 599 may also manage data transfer, decision logic, and triggering of alert conditions. Local storage SD card 550 stores data for redundancy, tracking, calibration, and historical analysis, while output hardware 545 may include user-visible or audible indications such as LEDs or a buzzer for on-site alerting.

Sensor modules 530 include tier 1 sensors 531 and tier 2 sensors 532, arranged in a multi-tiered sensing approach to optimize both detection accuracy and power consumption. Tiered sensor configuration enables deployment of WARM framework 170 in remote terrains with constrained energy availability. Solar panel 520 may be implemented, for example, as a Voltaic Systems waterproof, scratch-resistant, and UV-resistant panel rated at 6 V and up to 2 W, with 12 high-efficiency photovoltaic cells providing a nominal 0.5 V per cell. The availability of solar energy is naturally restricted to daylight hours and may be further reduced under conditions of cloud cover, haze, or dust. By utilizing the tiered sensor architecture, WARM framework 170 reduces continuous power draw while maintaining high detection fidelity.

Tier 1 sensors 531 operate as predictive monitors of environmental conditions that influence wildfire risk. In one example configuration, tier 1 sensors 531 include a temperature and humidity sensor, such as a DHT11 or DHT22 type digital sensor, and an anemometer for measuring windspeed. Data from tier 1 sensors 531 are used to compute a hot-dry-windy (HDW) index value or equivalent fire weather index metric. The HDW index calculation determines the likelihood that current conditions are conducive to ignition or spread of wildfire. Processing circuitry 599 receives input from tier 1 sensors 531 and compares the computed risk value against one or more thresholds. When the computed index reaches or exceeds a defined first threshold, tier 2 sensors 532 are activated.

Tier 2 sensors 532 are configured for direct detection of fire events and fire-related phenomena. For instance, tier 2 sensors 532 may include infrared (IR) sensors for detecting flame signatures and carbon monoxide sensors for detecting combustion gases. Tier 2 sensors 532 may be based on Winsen MQ7 carbon monoxide sensors or equivalent modules, and on IR sensors configured with adjustable gain or sensitivity for flame detection. Until triggered, tier 2 sensors 532 operate in a low-power sleep mode to conserve energy. Once tier 2 sensors 532 are activated, processing circuitry 599 receives their input data streams and integrates the fire-detection measurements with environmental risk assessment values from tier 1 sensors 531. Tier 2 sensors 532 remain engaged until the risk index falls below a threshold, or alternatively until a second lower threshold is satisfied, indicating no current fire risk or active fire presence.

Output hardware 545 may receive control signals from processing circuitry 599 to activate LEDs for visual alerts or a buzzer for audible alerts, enabling immediate on-site indication of wildfire conditions. In parallel, local storage SD card 550 receives data feeds from processing circuitry 599 to archive measurements, thresholds, and events for subsequent forensic review or machine-learning model training. Power supply battery 540 ensures continuous availability of power to processing circuitry 599 and associated components, even under intermittent solar charging conditions. In this configuration, WARM framework 170 achieves continuous risk monitoring and early detection capability, balancing the competing requirements of detection accuracy and ultra-low power consumption.

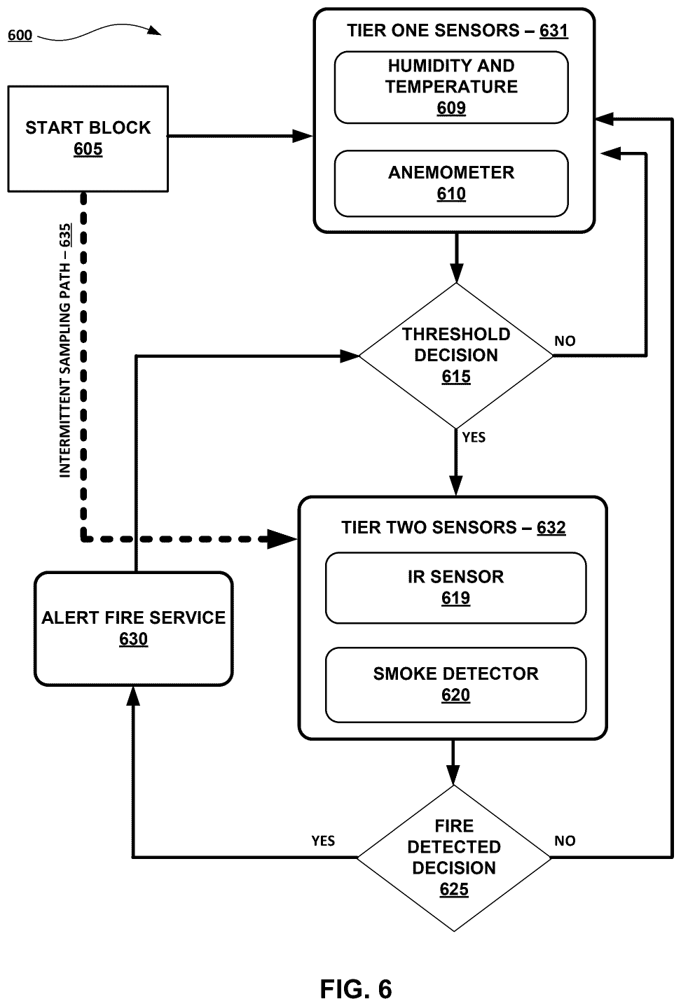

FIG. 6 provides a logic diagram of WARM framework 170 which uses a tiered sensing approach to enable fire detection with limited access to power, in accordance with aspects of the disclosure. The thresholding approach enables reduced power consumption while effectively enabling monitoring of weather conditions that foster the occurrence and spread of fires. In particular, depicted here are the logic elements detailing the activation and control of tier one sensors 631 and tier two sensors 632 within WARM framework 170.

Logic diagram 600 begins at start block 605 and proceeds to activate tier one sensors 631, which include humidity and temperature 609 and anemometer 610. Tier one sensors 631 function as predictive sensors, monitoring environmental conditions that foster the occurrence and spread of fires. Values from humidity and temperature 609 and anemometer 610 are used to determine if a threshold decision 615 is satisfied. If the threshold decision 615 is not satisfied, processing returns to tier one sensor(s) 631 and again reads values from humidity and temperature 609 and anemometer 610 for continuous monitoring. If the threshold decision 615 is satisfied, then tier two sensors 632 are activated. Tier two sensors 632, which normally remain in a low-power sleep state to conserve energy, include IR sensor 619 and smoke detector 620. Once activated, IR sensor 619 and smoke detector 620 are read to determine whether a fire detected decision 625 is satisfied. If the fire detected decision 625 is satisfied, processing advances to alert fire service 630. If the fire detected decision 625 is not satisfied, processing returns to tier one sensor(s) 631 and again reads values from humidity and temperature 609 and anemometer 610.

Intermittent sampling path 635 may also be used to trigger tier two sensors 632 from start block 605 to directly read IR sensor 619 and smoke detector 620, providing periodic redundancy in evaluating whether a fire detected decision 625 is satisfied even before a threshold decision 615 is reached.

The thresholding decision is enabled by the Hot, Dry, and Windy (HDW) indexing system. The HDW index was developed to determine conditions under which there is a high risk of fire incidence and the difficulty of managing fires. High values of the HDW index indicate favorable conditions for the rapid spread of fires, while low values suggest a lower risk of fire activity and spread. The index is calculated by multiplying windspeed (U) in meters per second (m/s) with the vapor pressure deficit (VPD) measured within 500 meters above the ground, as expressed according to Equation 1:

$$HDW = U \times VPD ( T , q ) .$$

The vapor pressure deficit does not use relative humidity, which is a ratio of vapor pressure (e) to saturation vapor pressure (e_s). Instead, the vapor pressure deficit represents the difference between these two variables. This difference indicates how much water the atmosphere can hold before precipitation occurs and serves as a practical measure of whether there is sufficient moisture in the atmosphere to support or inhibit fires.

The vapor pressure deficit is expressed according to Equation 2:

$$VPD = {e}_{s} ( T ) - e ( q ) ,$$

where eₛ=temperature-dependent vapor pressure (e.g., the temperature-dependent saturation vapor pressure) measured in hPa; and where e=moisture content-dependent vapor pressure measured in hPa.

The saturation vapor pressure is temperature-dependent, while the vapor pressure is moisture content-dependent, hence each variable is calculated according to Equation 3, set forth below, as follows:

$${e}_{s} ( T ) = 6.11 \times {e}^{( \frac{17.625 T}{243.04 + T} )} ,$$

and further according to Equation 4, set forth below, as follows:

$$e ( q ) = 6.11 \times {e}^{( \frac{17.625 Td}{243.04 + Td} )} .$$

The temperature (T) in Celsius (C) is sampled from the sensor, while the dew point temperature (Td), which is the temperature to which air must be cooled (at constant pressure) to achieve a relative humidity of 100%, is calculated according to Equation 5, set forth below, as follows:

$$Td = \frac{243.04 [ ln ( RH / 100 ) + ( 17.625 x T / 243.04 + T ) ]}{17.625 - ln [ ( R H / 100 ) - ( 17.625 x T / 243.04 + T ) ]} .$$

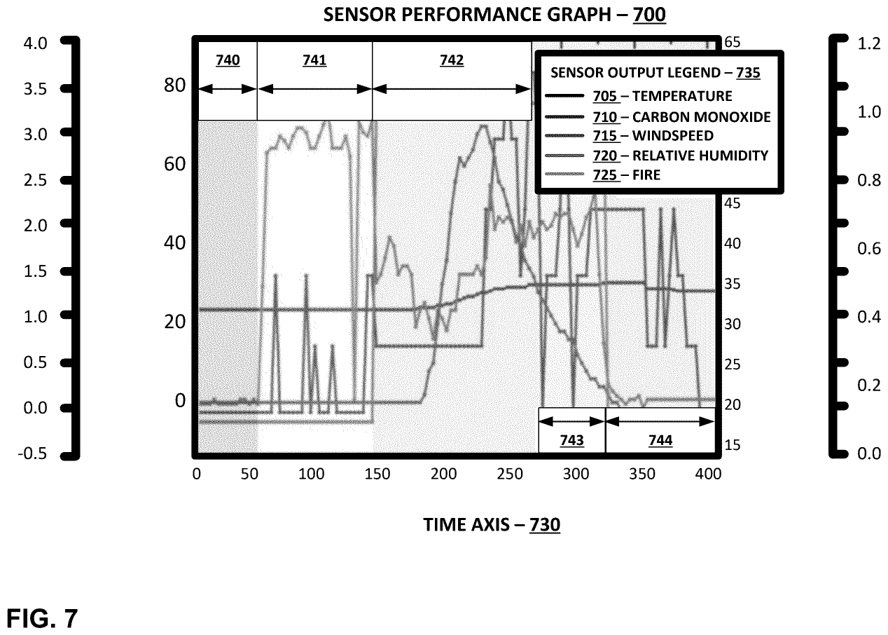

FIG. 7 depicts sensor performance graph 700 showing sensor output under various conditions to mimic weather and fire environments, in accordance with aspects of the disclosure. Sensor output legend 735 identifies temperature 705, carbon monoxide 710, windspeed 715, relative humidity 720, and fire 725, which vary progressively across time axis 730.

Sensor performance graph 700 includes operational phases divided into interval 740, interval 741, interval 742, interval 743, and interval 744. Interval 740 corresponds to a fan off fire off interval in which all sensors remain at baseline, with fire 725 undetected and carbon monoxide 710 at low levels. Interval 741 corresponds to a fan on fire off interval in which airflow increases windspeed 715 while fire 725 remains off, resulting in modest increases in temperature 705 and fluctuations in relative humidity 720. Interval 742 corresponds to a fan on fire on interval at low speed, during which fire 725 ignites and carbon monoxide 710 rises sharply, accompanied by increases in temperature 705 and further decreases in relative humidity 720. Interval 743 corresponds to a fan on fire on interval at high speed, in which windspeed 715 further increases and drives additional variation in fire 725 detection and carbon monoxide 710 concentration, with temperature 705 rising and relative humidity 720 dropping further. Interval 744 corresponds to a fan off fire off interval after suppression, in which temperature 705, carbon monoxide 710, and fire 725 outputs decrease toward baseline and relative humidity 720 begins to recover.

Sensor performance graph 700 therefore demonstrates coordinated variation of sensor outputs under staged test conditions, validating multi-sensor detection of fire presence and environmental influences across distinct operational intervals.

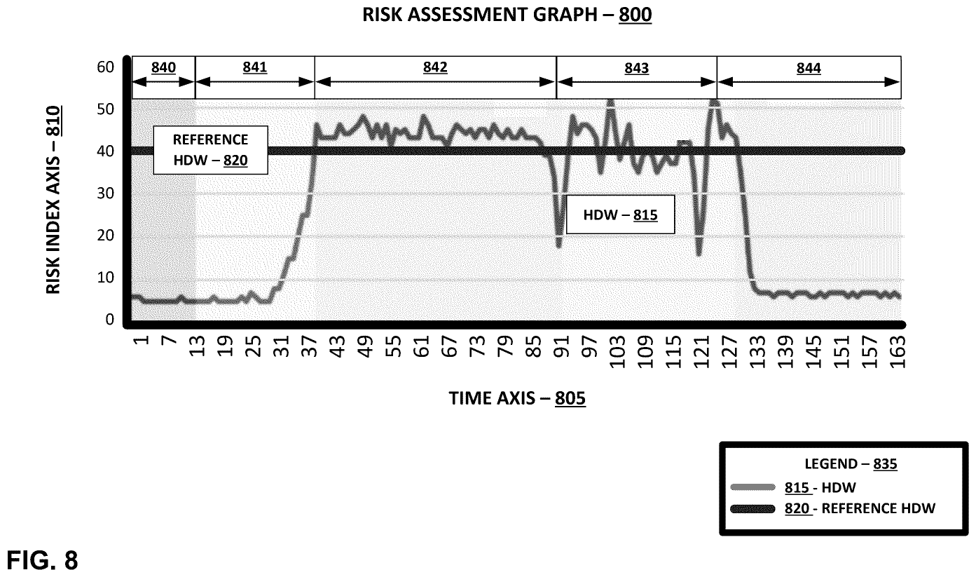

FIG. 8 depicts risk assessment graph 800 showing the risk levels based on the HDW index, in accordance with aspects of the disclosure. Time axis 805 represents the progression of time in seconds, while risk index axis 810 represents the calculated risk index values. HDW 815 is plotted dynamically and compared against reference HDW 820, which represents the reference threshold condition for the day. Legend 835 identifies HDW 815 and reference HDW 820 within risk assessment graph 800.

Risk assessment graph 800 is divided into distinct operational intervals to illustrate the effect of environmental and fire conditions. Interval 840 corresponds to a fan off fire off interval in which HDW 815 remains low, reflecting baseline environmental stability. Interval 841 corresponds to a fan on fire off interval where airflow is introduced by the fan while fire remains absent, causing HDW 815 to increase as conditions become more favorable for fire spread. Interval 842 corresponds to a fan on fire on (low speed) interval in which airflow and fire are both present, resulting in a sustained elevation of HDW 815 above reference HDW 820. Interval 843 corresponds to a fan on fire on (high speed) interval in which both fire activity and elevated windspeed drive HDW 815 to peak fluctuations, highlighting conditions of greatest fire risk. Interval 844 corresponds to a fan off fire off interval following fire suppression, during which HDW 815 decreases toward baseline levels as both fire and airflow subside.

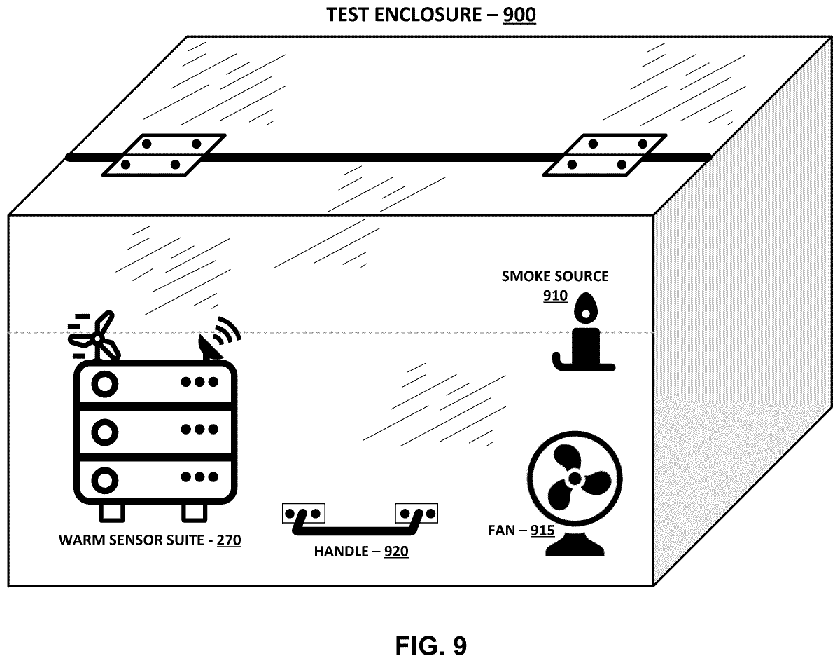

FIG. 9 depicts test enclosure 900 including warm sensor suite 270 along with smoke source 910, fan 915, and handle 920, in accordance with aspects of the disclosure. Test enclosure 900 was configured to provide a controlled environment for data collection by WARM framework 170. Of course, warm sensor suite 270 when provisioned into the field will not operate in-situ within test enclosure 900.

Sensor results: With reference to FIG. 9, test enclosure 900 was constructed with dimensions of approximately 20″×20″×16″ for controlled data collection. Sensor data for temperature, humidity, carbon monoxide, windspeed, and fire detection variables were gathered within test enclosure 900 (see FIGS. 7 and 8). Fan 915 was used to direct forced air toward the anemometer of warm sensor suite 270, controlling its speed by adjusting fan operation. Smoke source 910 was introduced into test enclosure 900 to emulate combustion activity. The fan speed was alternated as illustrated in FIG. 7, including transitions corresponding to interval 740, interval 741, interval 742, interval 743, and interval 744.

Sensor data was collected at each stage. As depicted in FIG. 7, fire 725 output from the infrared sensor alternates between 1 and 0 due to its operation in digital mode. The HDW index calculated from these experiments serves as the reference index for the day. High-risk feedback is generated when HDW 815 equals or exceeds reference HDW 820 (see FIG. 8). The risk of fire occurrence is influenced by moisture content in the air and the presence of winds, which support combustion and aid in the spread of fires. The HDW indexing system determines daily fire risks based on this data (see FIG. 8). The data sampled from warm sensor suite 270 was processed through a model that calculates the highest HDW index for the day. Wind speeds monitored by weather stations provide public safety information regarding storms. WARM framework 170 reports a dust storm or gale when wind speeds exceed 47 mph, and a heat wave when temperatures surpass 100° F.

Dataset: The HDW index was evaluated using a dataset from the Climate Forecast System Reanalysis (CFSR) provided by the National Centers for Environmental Prediction (NCEP), covering a span of 30 years. This dataset indicates that the indexing system effectively predicted days when fire management would be challenging if fires occurred. Nonetheless, the evaluation was limited to four significant wildfires across various locations in the United States. Further testing may be utilized to train an artificial intelligence model of WARM framework 170 to increase predictive accuracy of fire risk and fire events, thus increasing overall operational reliability of WARM framework 170.

The prototype sensors and microcontrollers used for the evaluation restricted the extent of testing, which impacted the system's spatial resolution. Although functional, these sensors are prone to errors. An artificial intelligence model of WARM framework 170 could be improved further through the use of one or more industry-standard sensor suites with access to greater training datasets, additional machine learning (ML) training domains, and better a priori calibration information for the sensors utilized.

In such a way, integrating both fire management and continuous surveillance through the use and implementation of WARM framework 170 can enhance fire mitigation efforts. While WARM framework 170 focuses on assessing fire risk, deployment along powerlines may be prioritized throughout key areas where remote fire prevention and mitigation are most impactful. Although the current indexing system utilized by WARM framework 170 has been validated through retrospective analysis, expanding its testing to a broader scale will solidify its reliability and improve predictive accuracy of AI models trained by WARM framework 170. Furthermore, reducing needed maintenance for warm sensor suite 270 will improve overall reliability and useful life, thus increasing the overall effectiveness of WARM framework 170 as a viable monitoring technology.

WARM framework 170 may be further improved by expanding the training dataset for an AI model to include fire outbreak data from various locations and associated weather conditions. This will contribute to developing a more robust indexing system and enhancing accuracy. Further benchmarking of warm sensor suite 270 utilized by WARM framework 170 will further increase reliability through greater predictive accuracy. Additionally, incorporating a camera module into the tier 2 portion of warm sensor suite 270 will advance fire detection capabilities. Further still, data collected may be transmitted via multiple redundant wireless bands over redundant and complementary networks to fire response teams to enable timely alerts and responses during high-risk periods. For instance, warm sensor suite 270 may include, for example, a Long Range (LoRa) module into the design which will facilitate data transmission from power stations and powerlines to base stations.

A Long Range (LoRa) module enables low-power, long-distance communication, ideal for remote monitoring and sensor networks. LoRa enables devices to transmit data over several kilometers with minimal energy consumption. LoRa technology is suited for applications requiring infrequent data transmission, such as environmental monitoring and asset tracking, thanks to its wide-area coverage and robust performance even in challenging conditions. Its cost-effectiveness and low power requirements make it suitable for battery-operated devices, offering reliable communication without extensive infrastructure.

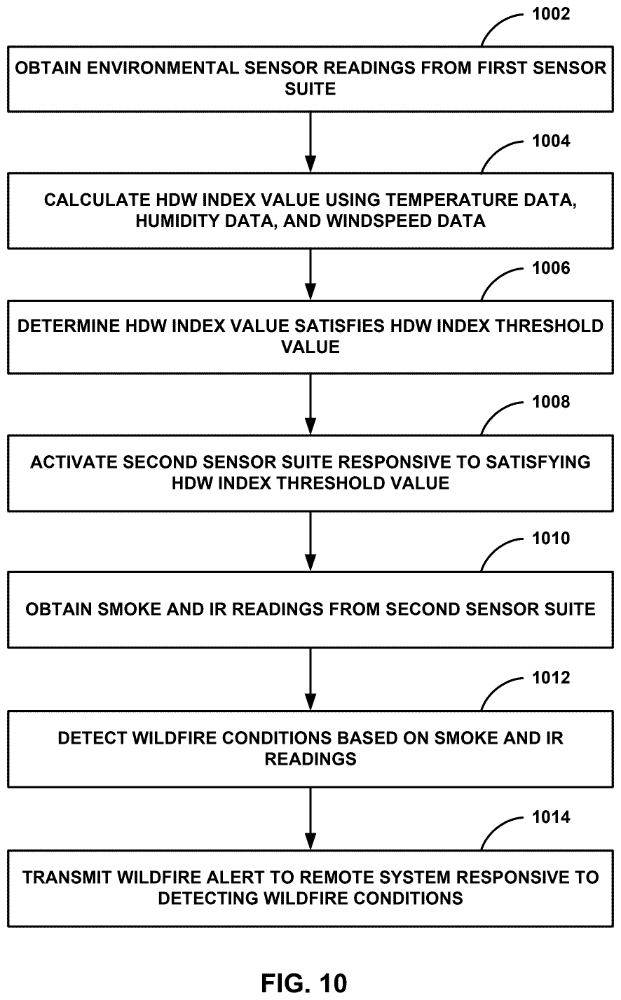

FIG. 10 is a flow diagram illustrating an example method for wildfire monitoring and detection, in accordance with aspects of this disclosure. FIG. 10 is described with respect to computing device 100 of FIG. 1 and the elements shown therein, including first sensor suite 120, second sensor suite 122, wildfire risk assessment 175, HDW threshold 176, HDW index calculation 177, and wildfire alert 180. However, the techniques of FIG. 10 may be performed by different components of computing device 100 or by additional or alternative systems.

Processing circuitry of computing device 100 may be configured to obtain environmental sensor readings from a first sensor suite (1002). For example, first sensor suite 120 may generate environmental sensor readings that include temperature data, humidity data, and windspeed data local to first sensor suite 120.

Processing circuitry of computing device 100 may be configured to calculate an HDW index value using temperature data, humidity data, and windspeed data (1004). For example, wildfire risk assessment 175 may execute HDW index calculation 177 using the environmental sensor readings provided by first sensor suite 120.

Processing circuitry of computing device 100 may be configured to determine the HDW index value satisfies an HDW index threshold value (1006). For example, wildfire risk assessment 175 may compare the calculated HDW index value to HDW threshold 176 to determine whether conditions indicate elevated wildfire risk.

Processing circuitry of computing device 100 may be configured to activate a second sensor suite responsive to satisfying the HDW index threshold value (1008). For example, responsive to wildfire risk assessment 175 determining that the HDW index value equals or exceeds HDW threshold 176, computing device 100 may activate second sensor suite 122, which is characterized by higher energy consumption than first sensor suite 120.

Processing circuitry of computing device 100 may be configured to obtain smoke and IR readings from the second sensor suite (1010). For example, second sensor suite 122 may output smoke readings 198 and infrared (IR) readings 199 subsequent to being activated by computing device 100.

Processing circuitry of computing device 100 may be configured to detect wildfire conditions based on smoke and IR readings (1012). For example, computing device 100 may analyze smoke readings 198 and infrared readings 199 generated by second sensor suite 122 to determine the presence of wildfire conditions.

Processing circuitry of computing device 100 may be configured to transmit wildfire alert(s) to remote system(s) responsive to detecting wildfire conditions (1014). For example, computing device 100 may output wildfire alert 180 via network interface 106 to a remote monitoring system to enable proactive fire response.

In this way, FIG. 10 illustrates a method for wildfire monitoring that combines low-power HDW-based risk assessment with selective activation of higher-power secondary sensors. The method improves overall energy efficiency of wildfire monitoring while increasing accuracy and responsiveness through multi-stage sensing and targeted alerting. This disclosure includes the following examples.

Example 1—A method comprising: obtaining environmental sensor readings from a first sensor suite of a wildfire monitoring system, wherein the environmental sensor readings include at least temperature data, humidity data, and windspeed data local to the first sensor suite; calculating a Hot, Dry, and Windy (HDW) index value using the temperature data, the humidity data, and the windspeed data; determining the HDW index value satisfies an HDW index threshold value; responsive to determining the HDW index value satisfies the HDW index threshold value, activating a second sensor suite characterized by a higher energy consumption than the first sensor suite; obtaining, from the second sensor suite subsequent to activating the second sensor suite, smoke and infrared (IR) readings; detecting wildfire conditions based on the smoke and infrared (IR) readings; and responsive to detecting the wildfire conditions, transmitting a wildfire alert to a remote system.

Example 2—The method of example 1, wherein the first sensor suite has a first energy draw less than a second energy draw of the second sensor suite, and wherein the method further comprises: iteratively obtaining the environmental sensor readings from the first sensor suite; and while iteratively obtaining the environmental sensor readings from the first sensor suite, maintaining the second sensor suite in a low power sleep state consuming less energy than the first energy draw of the first sensor suite while the second sensor suite remains in the low power sleep state.

Example 3—The method of example 1, further comprising: periodically activating the second sensor suite regardless of whether the HDW index value satisfies the HDW index threshold value; and determining, using the smoke and infrared (IR) readings from the second sensor suite, whether wildfire conditions are detected.

Example 4—The method of example 1, further comprising: transmitting the wildfire alert to emergency fire services or to a central monitoring service, or both.

Example 5—The method of example 1, further comprising: iteratively obtaining the environmental sensor readings; monitoring a geographic area for wildfire risk using the environmental sensor readings; and issuing the wildfire alert to emergency fire services or to a central monitoring service, or both, when the HDW index value satisfies the HDW index threshold value indicating a risk of wildfire, or when wildfire conditions are detected based on the smoke and infrared (IR) readings from the second sensor suite.

Example 6—The method of example 1, further comprising: calculating the HDW index based on a windspeed indicated by the windspeed data and a vapor pressure deficit calculated using the temperature data and a moisture content value derived from the humidity data for an altitude associated with a deployment location of the wildfire monitoring system.

Example 7—The method of example 1, further comprising: provisioning the wildfire monitoring system into a geographic area having remote terrain; wherein the first sensor suite and the second sensor suite are powered by one or more of solar power, battery power, or other renewable or stored energy sources; and issuing the wildfire alert from the wildfire monitoring system to a central monitoring station utilizing a Long Range (LoRa) wireless communications module powered by the one or more of solar power, battery power, or other renewable or stored energy sources.

Example 8—The method of example 1, further comprising: obtaining the temperature data from a temperature sensor of the first sensor suite; obtaining the humidity data from a humidity sensor of the first sensor suite; and obtaining the windspeed data from one or more windspeed sensors of the first sensor suite.

Example 9—The method of example 1, further comprising: obtaining carbon monoxide data from one or more carbon monoxide sensors for detecting gas emissions associated with wildfires from the second sensor suite; and obtaining smoke particulate emission data from one or more infrared (IR) sensors of the second sensor suite or one or more smoke sensors of the second sensor suite, or both.

Example 10—The method of example 1, further comprising: training a machine learning model using historical wildfire and weather data; and applying the trained model in combination with or as an alternative to the HDW index value to improve predictive accuracy of wildfire risk assessment.

Example 11—The method of example 1, further comprising: transmitting the wildfire alert using one or more wireless communication protocols including LoRa, cellular, or satellite, to provide communications redundancy.

Example 12—The method of example 1, further comprising: activating a visual or infrared camera within the second sensor suite, and obtaining image data in addition to the smoke and infrared (IR) readings for use in detecting wildfire conditions.

Example 13—The method of example 1, wherein determining the HDW index value satisfies the HDW index threshold value comprises comparing the HDW index value against a first threshold value to activate the second sensor suite; and wherein the method further comprises: deactivating the second sensor suite when the HDW index value falls below a second threshold value lower than the first threshold value.

Example 14—A system comprising: processing circuitry configured to: obtain environmental sensor readings from a first sensor suite of a wildfire monitoring system, wherein the environmental sensor readings include at least temperature data, humidity data, and windspeed data local to the first sensor suite; calculate a Hot, Dry, and Windy (HDW) index value using the temperature data, the humidity data, and the windspeed data; determine the HDW index value satisfies an HDW index threshold value; responsive to determining the HDW index value satisfies the HDW index threshold value, activate a second sensor suite characterized by a higher energy consumption than the first sensor suite; obtain, from the second sensor suite subsequent to activating the second sensor suite, smoke and infrared (IR) readings; detect wildfire conditions based on the smoke and infrared (IR) readings; and responsive to detecting the wildfire conditions, transmit a wildfire alert to a remote system.

Example 15—The system of example 14, wherein the first sensor suite has a first energy draw less than a second energy draw of the second sensor suite, and wherein the processing circuitry is further configured to: iteratively obtain the environmental sensor readings from the first sensor suite; and while iteratively obtaining the environmental sensor readings from the first sensor suite, maintain the second sensor suite in a low power sleep state consuming less energy than the first energy draw of the first sensor suite while the second sensor suite remains in the low power sleep state.

Example 16—The system of example 14, wherein the processing circuitry is further configured to: periodically activate the second sensor suite regardless of whether the HDW index value satisfies the HDW index threshold value; and determine, using the smoke and infrared (IR) readings from the second sensor suite, whether wildfire conditions are detected.

Example 17—The system of example 14, wherein the first sensor suite and the second sensor suite are powered by one or more of solar power, battery power, or other renewable or stored energy sources; and wherein the processing circuitry is further configured to: provision the wildfire monitoring system into a geographic area having remote terrain; and issue the wildfire alert from the wildfire monitoring system to a central monitoring station utilizing a Long Range (LoRa) wireless communications module powered by the one or more of solar power, battery power, or other renewable or stored energy sources.

Example 18—The system of example 14, wherein the processing circuitry is further configured to: obtain carbon monoxide data from one or more carbon monoxide sensors for detecting gas emissions associated with wildfires from the second sensor suite; and obtain smoke particulate emission data from one or more infrared (IR) sensors of the second sensor suite or one or more smoke sensors of the second sensor suite, or both.

Example 19—The system of example 14, wherein the processing circuitry is further configured to: compare the HDW index value against a first threshold value to activate the second sensor suite, and deactivate the second sensor suite when the HDW index value falls below a second threshold value lower than the first threshold value.

Example 20—Computer-readable storage media comprising instructions that, when executed, configure processing circuitry to: obtain environmental sensor readings from a first sensor suite of a wildfire monitoring system, wherein the environmental sensor readings include at least temperature data, humidity data, and windspeed data local to the first sensor suite; calculate a Hot, Dry, and Windy (HDW) index value using the temperature data, the humidity data, and the windspeed data; determine the HDW index value satisfies an HDW index threshold value; responsive to determining the HDW index value satisfies the HDW index threshold value, activate a second sensor suite characterized by a higher energy consumption than the first sensor suite; obtain, from the second sensor suite subsequent to activating the second sensor suite, smoke and infrared (IR) readings; detect wildfire conditions based on the smoke and infrared (IR) readings; and responsive to detecting the wildfire conditions, transmit a wildfire alert to a remote system.

Example 21—A computer program product comprising one or more instructions that, when executed by at least one processor, cause the at least one processor to perform any of the methods of examples 1-13.

Example 22—A device comprising means for performing any of the methods of examples 1-13.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method comprising:
obtaining environmental sensor readings from a first sensor suite of a wildfire monitoring system, wherein the environmental sensor readings include at least temperature data, humidity data, and windspeed data local to the first sensor suite;
calculating a Hot, Dry, and Windy (HDW) index value using the temperature data, the humidity data, and the windspeed data;
determining the HDW index value satisfies an HDW index threshold value;
responsive to determining the HDW index value satisfies the HDW index threshold value, activating a second sensor suite characterized by a higher energy consumption than the first sensor suite;
obtaining, from the second sensor suite subsequent to activating the second sensor suite, smoke and infrared (IR) readings;
detecting wildfire conditions based on the smoke and infrared (IR) readings; and
responsive to detecting the wildfire conditions, transmitting a wildfire alert to a remote system.

2. The method of claim 1, wherein the first sensor suite has a first energy draw less than a second energy draw of the second sensor suite, and wherein the method further comprises:
iteratively obtaining the environmental sensor readings from the first sensor suite; and
while iteratively obtaining the environmental sensor readings from the first sensor suite, maintaining the second sensor suite in a low power sleep state consuming less energy than the first energy draw of the first sensor suite while the second sensor suite remains in the low power sleep state.

3. The method of claim 1, further comprising:
periodically activating the second sensor suite regardless of whether the HDW index value satisfies the HDW index threshold value; and
determining, using the smoke and infrared (IR) readings from the second sensor suite, whether wildfire conditions are detected.

4. The method of claim 1, further comprising:
transmitting the wildfire alert to emergency fire services or to a central monitoring service, or both.

5. The method of claim 1, further comprising:
iteratively obtaining the environmental sensor readings;
monitoring a geographic area for wildfire risk using the environmental sensor readings; and
issuing the wildfire alert to emergency fire services or to a central monitoring service, or both, when the HDW index value satisfies the HDW index threshold value indicating a risk of wildfire, or when wildfire conditions are detected based on the smoke and infrared (IR) readings from the second sensor suite.

6. The method of claim 1, further comprising:
calculating the HDW index based on a windspeed indicated by the windspeed data and a vapor pressure deficit calculated using the temperature data and a moisture content value derived from the humidity data for an altitude associated with a deployment location of the wildfire monitoring system.

7. The method of claim 1, further comprising:
provisioning the wildfire monitoring system into a geographic area having remote terrain;
wherein the first sensor suite and the second sensor suite are powered by one or more of solar power, battery power, or other renewable or stored energy sources; and
issuing the wildfire alert from the wildfire monitoring system to a central monitoring station utilizing a Long Range (LoRa) wireless communications module powered by the one or more of solar power, battery power, or other renewable or stored energy sources.

8. The method of claim 1, further comprising:
obtaining the temperature data from a temperature sensor of the first sensor suite;
obtaining the humidity data from a humidity sensor of the first sensor suite; and
obtaining the windspeed data from one or more windspeed sensors of the first sensor suite.

9. The method of claim 1, further comprising:
obtaining carbon monoxide data from one or more carbon monoxide sensors for detecting gas emissions associated with wildfires from the second sensor suite; and
obtaining smoke particulate emission data from one or more infrared (IR) sensors of the second sensor suite or one or more smoke sensors of the second sensor suite, or both.

10. The method of claim 1, further comprising:
training a machine learning model using historical wildfire and weather data; and
applying the trained model in combination with or as an alternative to the HDW index value to improve predictive accuracy of wildfire risk assessment.

11. The method of claim 1, further comprising:
transmitting the wildfire alert using one or more wireless communication protocols including LoRa, cellular, or satellite, to provide communications redundancy.

12. The method of claim 1, further comprising:
activating a visual or infrared camera within the second sensor suite, and obtaining image data in addition to the smoke and infrared (IR) readings for use in detecting wildfire conditions.

13. The method of claim 1, wherein determining the HDW index value satisfies the HDW index threshold value comprises comparing the HDW index value against a first threshold value to activate the second sensor suite; and
wherein the method further comprises:
deactivating the second sensor suite when the HDW index value falls below a second threshold value lower than the first threshold value.

14. A system comprising:
processing circuitry configured to:
obtain environmental sensor readings from a first sensor suite of a wildfire monitoring system, wherein the environmental sensor readings include at least temperature data, humidity data, and windspeed data local to the first sensor suite;
calculate a Hot, Dry, and Windy (HDW) index value using the temperature data, the humidity data, and the windspeed data;
determine the HDW index value satisfies an HDW index threshold value;
responsive to determining the HDW index value satisfies the HDW index threshold value, activate a second sensor suite characterized by a higher energy consumption than the first sensor suite;
obtain, from the second sensor suite subsequent to activating the second sensor suite, smoke and infrared (IR) readings;
detect wildfire conditions based on the smoke and infrared (IR) readings; and
responsive to detecting the wildfire conditions, transmit a wildfire alert to a remote system.

15. The system of claim 14, wherein the first sensor suite has a first energy draw less than a second energy draw of the second sensor suite, and wherein the processing circuitry is further configured to:
iteratively obtain the environmental sensor readings from the first sensor suite; and
while iteratively obtaining the environmental sensor readings from the first sensor suite, maintain the second sensor suite in a low power sleep state consuming less energy than the first energy draw of the first sensor suite while the second sensor suite remains in the low power sleep state.

16. The system of claim 14, wherein the processing circuitry is further configured to:
periodically activate the second sensor suite regardless of whether the HDW index value satisfies the HDW index threshold value; and
determine, using the smoke and infrared (IR) readings from the second sensor suite, whether wildfire conditions are detected.

17. The system of claim 14, wherein the first sensor suite and the second sensor suite are powered by one or more of solar power, battery power, or other renewable or stored energy sources; and
wherein the processing circuitry is further configured to:
provision the wildfire monitoring system into a geographic area having remote terrain; and
issue the wildfire alert from the wildfire monitoring system to a central monitoring station utilizing a Long Range (LoRa) wireless communications module powered by the one or more of solar power, battery power, or other renewable or stored energy sources.

18. The system of claim 14, wherein the processing circuitry is further configured to:
obtain carbon monoxide data from one or more carbon monoxide sensors for detecting gas emissions associated with wildfires from the second sensor suite; and
obtain smoke particulate emission data from one or more infrared (IR) sensors of the second sensor suite or one or more smoke sensors of the second sensor suite, or both.

19. The system of claim 14, wherein the processing circuitry is further configured to:
compare the HDW index value against a first threshold value to activate the second sensor suite, and deactivate the second sensor suite when the HDW index value falls below a second threshold value lower than the first threshold value.

20. Computer-readable storage media comprising instructions that, when executed, configure processing circuitry to:
obtain environmental sensor readings from a first sensor suite of a wildfire monitoring system, wherein the environmental sensor readings include at least temperature data, humidity data, and windspeed data local to the first sensor suite;
calculate a Hot, Dry, and Windy (HDW) index value using the temperature data, the humidity data, and the windspeed data;
determine the HDW index value satisfies an HDW index threshold value;
responsive to determining the HDW index value satisfies the HDW index threshold value, activate a second sensor suite characterized by a higher energy consumption than the first sensor suite;
obtain, from the second sensor suite subsequent to activating the second sensor suite, smoke and infrared (IR) readings;
detect wildfire conditions based on the smoke and infrared (IR) readings; and
responsive to detecting the wildfire conditions, transmit a wildfire alert to a remote system.
